(19) United States
(12) Patent Application Publication
(10) Pub. No.: US 2006/0106670 A1
(43) Pub. Date: May 18, 2006

(54) System and method for interactively and progressively determining customer satisfaction within a networked community

(76) Inventors: Simin Cai, Basking Ridge, NJ (US); Song Steven Wang, Swedesboro, NJ (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 10/986,768

(22) Filed: Nov. 15, 2004

(51) Int. Cl. G07B 15/00; G07B 15/02

(52) U.S. Cl. 705/13

(57) ABSTRACT

A method and system for interactively and progressively processing and determining customer satisfaction from data gathered within an online community comprises of a group of participants connected via a computer network such as the Internet. A customer satisfaction and experience processing system comprises a participant or user interface (“front interface”), a database, a search engine, a customer satisfaction processing algorithm, an intelligent optimizer, and an optional report generator. The front interface is accessible via the network, thereby allowing any participant to interactively share experiences with respct to listed items (i.e., products or services). The database stores identification information and data pertaining to the participants' satisfaction and experiences with particular items. The algorithm processes the input data and produces ranking scores for individual items. The intelligent optimizer analyzes a participant's individual profile to predict and/or recommend one or more of the items from those offered by many different providers, which are the items most likely to provide the participant with the highest level of satisfaction and the best customer experience. The report generator conducts marketing analysis and produces electronic reports for customers and item providers. The search engine permits retrieval of data from the database upon participants' input queries.

### 1. FIELD OF THE INVENTION

The present invention relates to electronic commerce and more particularly, to a method and system for interactively and progressively determining customer satisfaction among a community of participants connected via a computer network.

### 2. DESCRIPTION OF RELATED ART

A customer (e.g., consumer) of products or services typically chooses to buy a certain item (i.e., product or service) from a variety of similar and competitive items based on a determination as to which particular item is likely to give the customer the greatest level of satisfaction. Accordingly, prospective customers wish to project or estimate the anticipated level of satisfaction achieved from certain items before they purchase them. Often, a customer is willing to share his/her experience with and opinion of a purchased item with others. Item providers are generally interested in understanding the perceptions of customers and others as they pertain to their items as well as the overall market in which they participate.

Prospective customers can research items through a variety of conventional sources of item information. For example, commercial advertisements and other marketing materials enable item providers to supply certain information, usually biased for and/or against particular items, directly to prospective customers. Web sites such as CNET.com provide prospective customers with relevant information including editorial reviews and product descriptions, and also enable customers to exchange evaluations and rate particular items. However, such web sites only provide a single overall rating (e.g., a thumbs up or a thumbs down) based on customers' experiences and fail to present a prospective customer with ratings relating to specific factors such as perceived value, perceived quality, reliability, etc. Consumer guides such as those from J.D. Power provide prospective customers with quality and customer satisfaction research based on survey responses submitted from customers, but only related to providers as a whole and not to individual items. Additionally, online retailers such as Amazon.com post customer reviews to inform prospective customers about the items that they sell.

The American Customer Satisfaction Index (ACSI) is an independent measure of household consumption experience. The ACSI tracks trends in customer satisfaction and provides benchmarks of the customer economy for companies, industry trade associations, and government agencies. The ACSI is funded in part by corporate subscribers who receive industry benchmarking data and company-specific information about financial returns from improving customer satisfaction. However, the ACSI is principally geared toward providing marketing and customer trends to providers only. It does not provide an online community for customers to share their satisfaction and experiences concerning items with one another. Moreover, the ACSI does not offer businesses with a means to directly interact with customers. Furthermore, the ACSI does not provide potential customers with research information or recommendations regarding particular items.

No means is currently available that allows customers to interactively exchange experiences, reviews, and opinions about items through a centralized and dedicated facilitator, particularly one which is not sponsored (i.e., not biased toward certain items) by one or more item providers. Moreover, there is no centralized online system that enables item providers to communicate with and to interactively provide care to existing and prospective customers. Conventional online systems fail to compute and provide customer satisfaction and experience grades based on numerous factors such as price, quality, value, and satisfaction, as well as particular customer characteristics and behavior. Furthermore, conventional systems are incapable of intelligently choosing one or more items from a pool of similar items, which will most likely give a particular prospective customer the greatest anticipated level of satisfaction.

### SUMMARY OF THE INVENTION

The present invention overcomes these and other deficiencies of the related art by providing a method and system for centrally processing customer satisfaction and experience data gathered interactively and progressively within an online community, i.e., a group of participants connected at one time or another via a computer network such as the Internet.

In an embodiment of the invention, a computer system for determining customer satisfaction with an item comprises: a database, wherein the database stores first data measuring one or more customer's satisfaction with a first item, wherein the first data includes two or more quantified values rating different aspects of customer satisfaction; and a computing device for processing the first data and generating a customer satisfaction score for the first item. The computing device comprises a computer server enabling communication with one or more remote devices and a portion of the first data is received from the one or more remote devices. The customer satisfaction score can comprise two parameters representing a value of one of the quantified values rating different aspects of customer satisfaction statistically computed over a plurality of customers. The customer satisfaction score can comprise an overall grade based on the two or more quantified values rating different aspects of customer satisfaction. The computing device can process second data measuring one or more customer's satisfaction with a second item, generate a customer satisfaction score for the second item, and rank the first item relative to the second item according to the customer satisfaction scores. A search engine can be provided to permit the one or more remote devices to locate the first data within the database. A personal profile of a customer or a prospective customer can be processed to generate a list recommending one or more of the first and second items based on the personal profile. A report generator can be provided to generate a report based on the personal profile and/or the first and second data. The item can be a product or service, and the system is preferably not biased toward a particular provider of the product or service.

In another embodiment of the invention, a method for determining customer satisfaction with an item comprises the steps of: gathering first data relating to a plurality of customers' levels of satisfaction with respect to a first item, wherein the first data comprises two or more quantified values for each of the customers rating two different aspects of satisfaction with respect to the first item; and generating a customer satisfaction score based on the first data for the first item. The step of gathering first data comprises the step of receiving the two or more quantified values for each of the customers from one or more remote devices. The customer satisfaction score comprises statistical values of the two or more quantified values for each of the customers statistically computed over all of the plurality of customers. The customer satisfaction score comprises an overall grade based on the statistical values. The method can further comprise the steps of: gathering second data relating to a plurality of customers' levels of satisfaction with respect to one or more second items, wherein the second data comprises two or more quantified values for each of the customers rating two different aspects of satisfaction with respect to each of the second items; and generating a customer satisfaction score based on a portion of the second data for each one of the second items. The method can further comprise the step of ranking the first and the second items relative to one another according to the satisfaction scores. The method can further comprise the steps of: receiving a personal profile for a customer or a prospective customer, and recommending one or more of the first and second items based on the personal profile. The method can further comprise the steps of: receiving a personal profile for a customer or a prospective customer, and generating a marketing report based on the personal profile and/or the first and second data.

In another embodiment of the invention, a computer system for recommending one or more items based on a personal profile of a customer comprises: a computer server, wherein the computer receives first data relating to a personal profile of a customer and an inquiry relating to a set of items, and a database, wherein the database stores second data relating to one or more quantified satisfaction values pertaining to each one of the set of items as surveyed from a plurality of customers, wherein the computer server processes said personal profile, the first data, and the second data, and generates a list of one or more recommended items selected from the set of items based upon the personal profile of said customer. The second data comprises one or more ranking scores pertaining to the set of items. The computer server can forward the list of one or more recommended items to a remote device of the customer. The quantified satisfaction values comprises two or more ratings for different aspects of customer satisfaction with respect to an item.

In another embodiment of the invention, a method for recommending one or more items based on a personal profile of a customer comprises the steps of: receiving a personal profile of a customer and an inquiry relating to a set of items, obtaining one or more quantified satisfaction values pertaining to each one of the set of items as surveyed from a plurality of customers, and generating a list of one or more recommended items selected from the set of items based upon the personal profile of the customer and the one or more quantified satisfaction values pertaining to each one of the set of items. The method can further comprise the step of forwarding the list of one or more recommended items to a remote device of the customer. The quantified satisfaction values comprise two or more ratings for different aspects of customer satisfaction with an item.

In another embodiment of the invention, a method for researching customer satisfaction with respect to an item comprises the steps of: sending an inquiry about an item to a centralized facilitator, and receiving, from the centralized facilitator, a satisfaction score for the item based upon a survey measuring one or more customer's satisfaction with the item, wherein the survey comprises two or more quantified values rating different aspects of customer satisfaction. The inquiry is sent by a device remote from the centralized facilitator and having Internet access. The customer satisfaction score can comprise two parameters, each of the parameters representing a value of one of the quantified values rating different aspects of customer satisfaction statistically computed over a plurality of customers. The customer satisfaction score can comprise an overall grade based on the two or more quantified values rating different aspects of customer satisfaction.

In another embodiment of the invention, a method for obtaining a recommendation of one or more items from a set of items comprises the steps of: sending a personal profile and an inquiry relating to set of items, and receiving a list of one or more recommended items selected from the set of items based upon the personal profile and one or more quantified satisfaction values pertaining to each one of the set of items as surveyed from a plurality of customers. The inquiry can be sent by a device remote from the centralized facilitator and having Internet access. The quantified satisfaction values rate different aspects of customer satisfaction and are statistically computed over the plurality of customers. Each of the quantified satisfaction values comprises an overall grade based on overall customer satisfaction.

In another embodiment of the invention, a method of assimilating customer feedback comprises the steps of: collecting feedback from the plurality of customers as it relates to an item provided by a provider, processing the feedback from a plurality of customers into first data, and forwarding the first data to the provider. The feedback can comprise negative feedback and the first data can comprise a complaint.

In another embodiment of the invention, a method for calculating a customer satisfaction index comprises the steps of: collecting data relating to a plurality of customer's satisfaction with a plurality of items provided by a plurality of providers, calculating a customer satisfaction score for each of the plurality of items based on a portion of the collected data, and calculating a customer satisfaction index across the plurality of providers based on the customer satisfaction score calculated for each of the plurality of items. The step of calculating a customer satisfaction index can be updated as the data is collected.

In another embodiment of the invention, a method of providing online customer care and support comprises the steps of: facilitating communication between a plurality of customers of an item provider with the provider, selecting one of the customers to serve as a representative of the provider, and facilitating communication between the selected customer and others of the plurality of customers. The selected customer can provide customer care and support from the provider to the others of the plurality of customers.

In another embodiment of the invention, a method of providing online customer care and support comprises the steps of: facilitating customer care and support among a plurality of item providers, and implementing a unified customer care procedure or interface across the plurality of item providers.

By using an online community, the present invention creates a social network of customers, which is not limited by time and space. Within this social network, customers can freely exchange their customer experiences with and ratings of items. The online community creates value for regular customers by providing them with better information regarding others' experiences and ratings of items. The online community also creates value for “good” item providers by spreading positive word-of-mouth (good ratings and comments) of satisfied customers through the community. Additionally, item providers can use the present invention to provide effective online services to their customer communities. The social network (or word of mouth) empowers an average Joe customer to deal with his/her item provider and to demand better total quality from them by leveraging the power of many customers, i.e., “the Internet democracy.”

The foregoing, and other features and advantages of the invention, will be apparent from the following, more particular description of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a customer satisfaction and experience processing system according to an embodiment of the invention;

FIG. 2 illustrates operation of a customer satisfaction ranking algorithm according to an embodiment of the invention;

FIG. 3 illustrates operation of an intelligent optimizer according to an embodiment of the invention;

FIG. 4 illustrates operation of a statistical report generator according to an embodiment of the invention;

FIG. 5 illustrates a customer satisfaction and experience processing system according to another embodiment of the invention;

FIG. 6 illustrates operation of the customer voice amplifier according to an embodiment of the invention; and

FIG. 7 illustrates operation of an online customer care facilitator according to an embodiment of the invention.

### DETAILED DESCRIPTION OF THE INVENTION

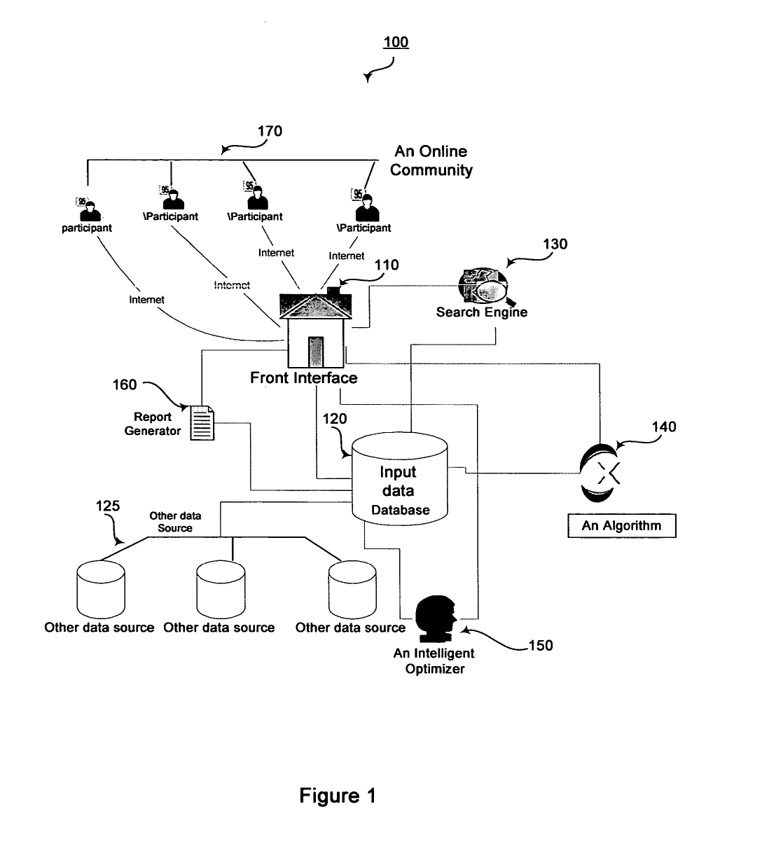

The present invention and its advantages may be understood by referring to FIGS. 1-7, wherein like reference numerals refer to like elements, and are described in the context of an online community of participants and a centralized and dedicated facilitator, which allows any participant to interactively share his/her experience with and satisfaction from certain commercially available items and to analyze information based on others' experiences with and satisfaction from those items. The centralized facilitator processes, preferably in an unbiased manner, customer satisfaction and experience data gathered from a plurality of participating customers, and presents specific information based on an analysis of such data to assist customers in choosing one or more items, from a variety of those available, which most likely will give the customer the highest level of satisfaction and most positive experience possible. Although the invention is described in the context of an electronic community communicating with one another and the facilitator through a public network such as the Internet, the invention can be implemented through any type of communications network (e.g., a private network), which connects the participants and facilitator by wired communications links, wireless communications links, or a combination thereof.

FIG. 1 illustrates a customer satisfaction and experience processing system 100 according to an embodiment of the invention. Particularly, the customer satisfaction and experience processing system 100 comprises a front interface 110 (i.e., a participant or user interface), a database 120, a search engine 130, a customer satisfaction processing algorithm 140, an intelligent optimizer 150, and an optional report generator 160. The front interface 110 preferably comprises a World Wide Web enabled communications interface hosted by one or more appropriate computer servers, the implementation of which is apparent to one of ordinary skill in the art, to allow one or more participants in an electronic community 170 to communicate with the various components of the system 100 and one another via a communications network such as the Internet. Participants can access the front interface 110 from a variety of communications devices, such as, but not limited to, home computers, laptops, public kiosks, and personal digital assistants (PDAs), or any other device that facilitates Internet access or network connection to the system 100.

Participants within the electronic community 170 comprise customers as well as item providers. Customers can be individual customers of commercially available items, e.g., the buyers or users of certain products/services offered for sale, as well as business entities, e.g., item distributors. Item providers include product providers (e.g., camera manufacturers) and service providers (e.g., a facility offering camera repair or maintenance), both domestic and foreign. In an embodiment of the invention, various participants are granted free access to use the system 100 upon registration. In another embodiment of the invention, only authorized or subscribed participants are permitted to access the system 100. Such authorization or subscription can be based on the payment of a fee or other consideration in exchange for such authorization or subscription.

The front interface 110 enables a participant to input appropriate information into the system 100, which is gathered and stored in the database 120. This information can comprise personal profile and identification information of the participant as well as information relating to customer satisfaction and/or experience surveys regarding one or more particular items to be evaluated. In an embodiment of the invention, the front interface 110 enables customer feedback to be directed to item providers and allows item providers to communicate with and provide online support and services to customers. Additionally, the front interface 110 can enable prospective customers to view products and services listed by item providers for the purpose of introduction and advertising, and to gather feedback and reviews from other customers concerning such items.

The database 120 is a progressive data repository that continuously collects input data from the participants of the electronic community 170. In an embodiment of the invention, customer input data is gathered via surveys accessible through the front interface 110 and/or by way of electronic groups/forums, e.g., an online collection of all topics related by similar characteristics, created by participants (customers or providers) under given criteria and/or created by the system 100. The progressive database 120 preferably comprises one or more relational databases, the implementation of which is apparent to one of ordinary skill in the art, indexed for fast data access. Additionally, pertinent information such as, but not limited to, product/service names and descriptions; price; quality; thumbnail images or other appropriate pictures of products; serial numbers; product tag numbers; service tracking numbers; manufacturer/distributor addresses or facilities locations; and Radio Frequency Identification (RFID) and other unique IDs associated with or related to the items are also stored in the database 120. Alternatively, this type of information, or a portion thereof, can be obtained through communications with one or more external data sources 125, the implementation of which is apparent to one of ordinary skill in the art, which are either coupled directly or indirectly to the database 120. For example, the external data sources 125 can be a web server maintained by a manufacturer or distributor of a product, or a service provider.

The search engine 130 is coupled to the front interface 110 and the database 120. The search engine 130 allows participants to search through the data contained in the database 120 as well as the external data sources 125. For example, the search engine 130 enables a participant to search for and to retrieve information about particular items, such as reviews, comments, and opinions inputted by other participants; as well as customer satisfaction data. The search engine 130 employs any type of computer implemented search engine, the identification and implementation of which is apparent to one of ordinary skill in the art. In a related embodiment of the invention, the search engine 130 enables a participant to search for information in web sites located throughout the world wide web.

The customer satisfaction processing algorithm 140 implements a quantitative technique that analyzes and/or summarizes participants' input data as well as appropriate data from other sources to generate anticipated customer satisfaction and experience grades in certain categories for any given item. The algorithm 140 can be implemented via software, hardware, or a combination thereof. In sum, the algorithm 140 processes customer satisfaction and experience data gathered from participants via the front interface 110. The output of the algorithm 140 comprises one or more grades related to various aspects of one or more items. This output assists a prospective customer in making an informed decision as to which item to buy, use, or engage in from those available. Operation of the algorithm 140 is further described below.

The intelligent optimizer 150 comprises software and/or hardware that analyzes pertinent data in a participant's individual profile vis-à-vis item information and/or the output data obtained from the customer satisfaction process algorithm 140 for such items, thereby enabling the system 100 to present the participant with one or more items recommended for that participant. The participant's profile is obtained from data input by the participant into the system 100 through interaction with the front interface 110. For example, the participant may be presented with one or more web page forms or data fields, the implementation of which is apparent to one of ordinary skill in the art, which include background questions for which the participant's answers are elicited. A participant's profile can comprise information such as, but not limited to, name, age, occupation, income level, address, education, customer behavior, purchasing characteristics, personality traits, technical prowess, past experience with particular item providers, budget for purchase of a desired item, preferred features sought in the item, and intended uses for the item. A participant's profile can be progressively updated at later times by, for example, the participant informing the system 100 about changes in personal information and particular items purchased or used, and the reasons for purchasing or using such items. In an embodiment of the invention, the participant's usage history of (i.e., navigation through) the front interface 110 is tracked and stored in the personal profile to identify tendencies and preferences of the participant, e.g., which items are viewed more often than others. The implementation of such usage history profile information is apparent to one of ordinary skill in the art. A participant's profile can be stored in the database 120 or by way of a cookie stored on the participant's computer. The implementation of such a cookie will be apparent to persons of ordinary skill in the art. The input data associated with the various items can be obtained from the database 120 and/or from the external data sources 125. Operation of the intelligent optimizer 150 is described in further detail below.

The report generator 160 implements software and/or hardware that facilitates marketing analysis based on the various data stored in the database 120 and/or external data sources 125, and produces detailed or aggregated marketing and customer related reports for participants. For example, the report generator 160 can generate reports relating to market trends and/or customer behavior on-demand by one of the participants. Operation of the report generator 160 is described in greater detail below.

The customer satisfaction and experience processing system 100, namely the combination of the front interface 110, the database 120, the search engine 130, the algorithm 140, the intelligent optimizer 150, and the report generator 160, form a centralized and dedicated facilitator for the participants within the electronic community 170 to perform research and to interactively exchange their customer experiences with, opinions, and knowledge of a variety of items. Additionally, item providers can use the system 100 to provide effective online services to their customer communities. In an embodiment of the invention, the customer satisfaction and experience processing system 100 is a neutral facilitator, i.e., unbiased and not sponsored by or financially dependent on any item providers, and is not limited to particular brands, providers, categories, or geographical regions. The customer satisfaction and experience processing system 100 allows participants to retrieve and review data input by other participants and ranking results based on such data, on a real time basis, as well as to input new data or create new electronic groups/forums for any items for which information is not yet in the database 120. In an embodiment of the invention, one or more languages other than English can be implemented to enable non-English speaking participants to communicate with one another.

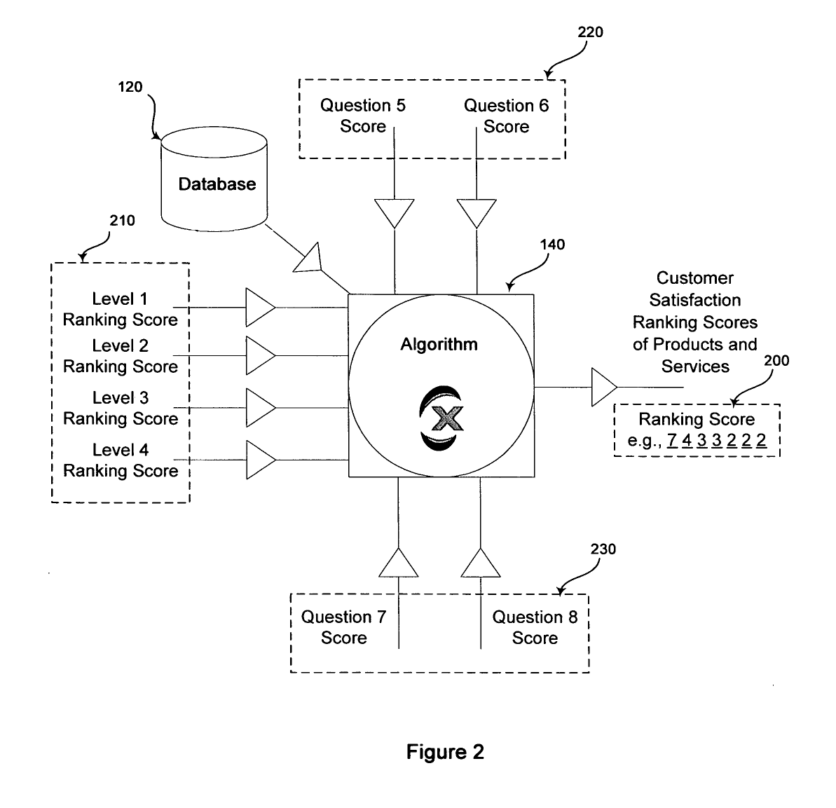

FIG. 2 illustrates operation of the customer satisfaction processing algorithm 140 according to an embodiment of the invention. Particularly, the customer satisfaction processing algorithm 140 generates a customer satisfaction ranking score or grade 200 for an item based on the participants' collective experiences with and satisfaction from the item. According to an exemplary embodiment of the invention, the ranking score 200 comprises seven informative sections or parameters (e.g., seven digits or numerical values), each of which is ascertained based on the collective input of the participants. The first informative section is an overall grade ascertained for the item, the second informative section to the fifth informative section show an a statistically computed, e.g., average, score for four levels of customer satisfaction (discussed below), the sixth informative section demonstrates information based on price/performance ratio, and the last informative section pertains to the core value for the provider of such item. Hence, the ranking score 200 is a composite indicator of several key factors each of which is individually ascertained based upon the collective input of all participants in the survey. One of ordinary skill in the art will recognize that there may be other factors for the item, which are pertinent to the prospective customer making an informed buying decision that can be included or substituted. In an alternative embodiment of the invention, the ranking score 200 can comprise graphical indicators (e.g., bar graphs) or words for each informative section, which are presented to the participant.

The price/performance ratio is related to customers' “perceived value” and/or “perceived quality” with respect to an item. Perceived value is an indicator of overall price given quality, and overall quality given price. Perceived quality is an indicator of overall quality, reliability, and the extent to which an item meets a customer's needs. In an embodiment of the invention, the price/performance ratio is measured on a scale of 1 to 3.

Core value is an indicator of customer satisfaction relative to the place of the item within the market. For example, one item provider might have a core value associated with having the lowest priced item among all similar items. Another item provider might have a core value associated with luxury or superb quality for an item. Item providers with similar core values are better measured relative to one another. Hence, item providers with a core value associated with lowest price for “necessity” items should be measured against one another and not measured against providers with a core value associated with high-priced luxury items.

In an embodiment of the invention, the input data for the algorithm 140 comprises answers to the following eight questions collected from a plurality of participants:

(1) Level 1: How are the functions and features?

(2) Level 2: How are the basic services?

(3) Level 3: How are the extended services?

(4) Level 4: How are the personalized services?

(5) Is the price for this item competitive?

(6) Would you recommend this item to others?

(7) What do you like best about this item?

(8) What do you like least about this item?

The first four questions 210 (i.e., Levels 1-4) are defined as layers of a customer satisfaction pyramid ranging from poor satisfaction to excellent satisfaction. For example, the answers to these questions are selected by the participant from a list of five predetermined answers offered via the front interface 110 as follows: 1—“Poor”, 2—“Fair”, 3—“Good”, 4—“Very Good”, and 5—“Excellent”. Each answer is associated with a numerical value in order to quantify a statistically computed, e.g., an average, rating based upon ratings received from a plurality of participants. For instance, the average value for a particular question would equal the sum of the number inputs received from all participants divided by the total number of participants who answered the question. Thus, if the average value is equal to 2.5, the level of satisfaction is halfway between “fair” and “good.”

The answers to the fifth and sixth questions 220 are selected by the participant from a list of three predetermined answers. For example, in response to the fifth question, a participant can select one of the following answers: 1—“Not Worth It”, 2—“Fairly Priced”, and 3—“A Bargain.” In response to the sixth question, a participant can select one of the following answers: 1—“Not Recommended”, 2—“Not Sure”, and 3—“Recommended.” In a manner similar to that described above with respect to the first four questions, the answers to the fifth and sixth questions each have a number associated therewith, which can be averaged for all participants answering the questions. For example, if the average result for the answer to the fifth question is 2.7, then participants are indicating that a particular item is close to a bargain. The answers to the seventh and eighth questions can be polled to determine which features are liked the best and the least by the participating customers.

The above eight questions 210, 220, and 230 are exemplary only. One of ordinary skill in the art will recognize that fewer, more, and alternative questions can be used to quantify participants' satisfaction with respect to a particular item. Moreover, surveys can use different sets of questions for different classes of items. Additionally, persons of ordinary skill in the art will recognize that a rating of “1” to “5” is exemplary only. Other rating scales can be used to enable more or less resolution in quantifying participant satisfaction for particular aspects of an item.

The output of the algorithm 140 is a seven section ranking score 200 with the first section comprising an overall grade for an item. Similar items can be ranked relative to one another according to their respective overall grades. Many overall grades available for most of the key items in a particular industry provides insight to item providers about that industry. For example, the overall grades or the entire ranking scores 200 from a certain number of key industries and key providers in an industry can be used to derive a real time customer satisfaction index for an industry or for a country's overall economy.

In an embodiment of the invention, the overall grade is an average or some other statistical function of the answers to the above eight questions, each of which can be given varying weights. The average is then normalized to a particular scale. For example, the overall grade can be associated with a single integer value from 0 to 9, each of which corresponds to a particular meaning as indicated below:

“0”—no rank available either due to the fact that this item is too new or the data is statistically insufficient (e.g., not enough participants have evaluated this item) to generate a meaningful rank, although the exact number needed can be relative to the specific nature of the item;

“1”—the overall rank of such item is the lowest of all available alternative items having similar characteristics, the item was judged unsatisfactory by the participants who have purchased/used it, and it is not recommended;

“2”—the overall rank of such item is well below average; the item is usually not satisfactory and is not recommended by the participants who have purchased/used it;

“3”—the overall rank of such item is below average; the item may offer some unique feature to meet some unique need of some specific participants, but, on average, it is not appreciated by the participants who have purchased/used it and is not recommended to the general public;

“4”—the overall rank of such item is on borderline average; the item is somewhat unsatisfactory by the participants who have purchased/used it;

“5”—the overall rank of such item is average, the item is somewhat satisfactory by the participants who have purchased/used it and it is recommended to customers who have a low expectation;

“6”—the overall rank of such item is slightly above average, the item is somewhat satisfactory and recommended by the participants who have purchased/used it;

“7”—the overall rank of such item is above average; the item is satisfactory and recommended by the participants who have purchased/used it;

“8”—the overall rank of such item is well above average; the item is satisfactory and recommended by the participants who have purchased/used it; and

“9”—the overall rank of such item is top of the line, the item is very satisfactory and strongly recommended by the participants who have purchased/used it.

The second through the fifth sections of the seven section ranking score 200 denote a statistically computed score, e.g., an average score, of the four levels of customer satisfaction questions noted above rounded to the nearest integer or a tenth of an integer. For example, the second section indicates the average degree of customers' satisfaction that participants have rated the functions and features of the item. The third section indicates the average degree of customer's satisfaction with the basic services of the item. Basic services comprise features that are expected by the customer and that are basic and/or taken for granted. The fourth section indicates the average degree of satisfaction with the extended services of the item. Extended services comprise features that are not common to all items and therefore, can be used to differentiate the item from other items. The fifth section indicates the average satisfaction with personalized services associated with the item. Personalized services comprise features the are directed to the individual customer. In an embodiment of the invention, the overall ranking score 200 can be presented as only the first section, wherein a participant may click on such ranking score 200 to be linked to more detailed information including all sections. The sixth section of the seven section ranking score 200 demonstrates the information based on price/performance ratio, i.e., the collection of participants' answers to questions five and six above. The seventh and last section includes information relative to core value for this item, i.e., the collection of participants' answers to questions seven and eight above.

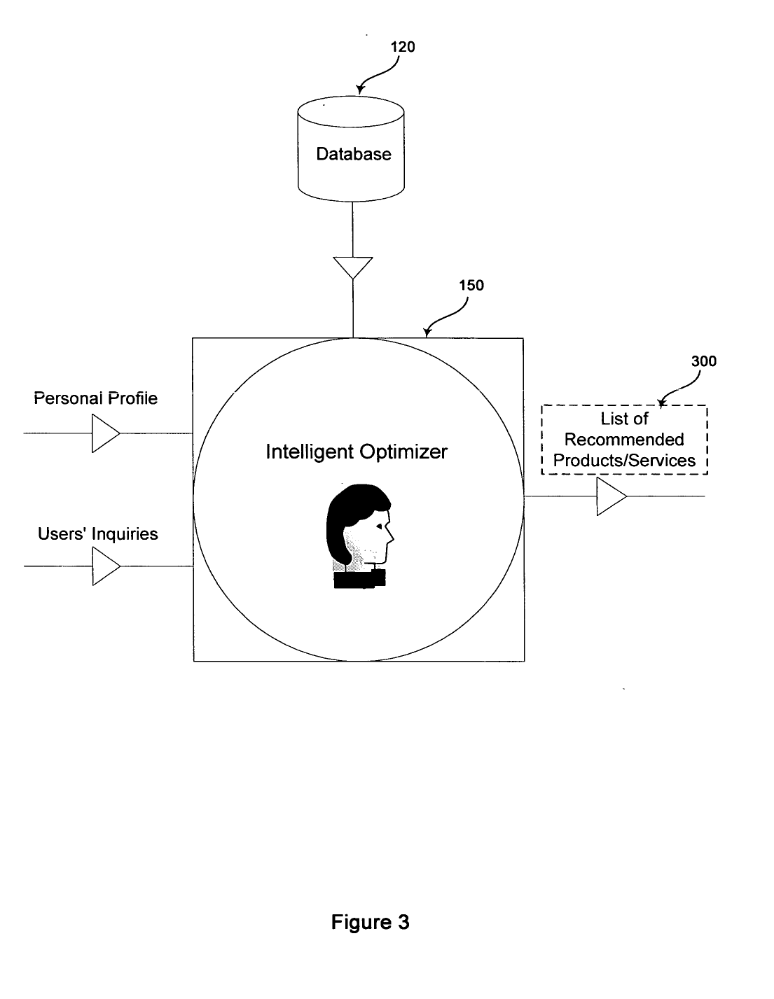

FIG. 3 illustrates operation of the intelligent optimizer 150 according to an embodiment of the invention. After analyzing the participant's personal information in his/her respective profile vis-à-vis the information associated with one or more items, the intelligent optimizer 150 recommends in a personalized manner a list one or more items 300, from a specific query of different item providers, which most likely offers this individual participant the greatest expected level of customer satisfaction and best customer experience possible. In other words, a shopper can be presented with a personalized list of recommended items based on that shopper's personal profile, e.g., income level, buying tendencies, technical prowess, item interests, geographic area, etc. For example, if the shopper informed the system 100, that he/she wants a digital camera and is technically sophisticated, familiar with digital camera features, has a large budget, and wants to use the images for printing high quality photographs rather than merely for email, the intelligent optimizer 150 would recommend, for example, one or more professional grade digital cameras with the highest resolution available. In an embodiment of the invention, the specific inquiry can be identified by a general class of items that the participant is interested in or can be based on the participant's intended use for the item. For example, n item such as a camera can be divided into two categories of intended uses: (1) professional use where the participant wishes to take professional quality photographs or (2) budget use where the participant merely wants a budget camera to take on vacation. The resulting list of recommended items 300 is presented to the customer through the front interface 110 along with item descriptive data obtained from either the database 120 or external data sources 125. The list of recommended items 300 can be limited to a certain number of items, for example, all cameras with a ranking score of 5 or higher will be retrieved from the database, together with the features of those cameras and the pros and cons for each.

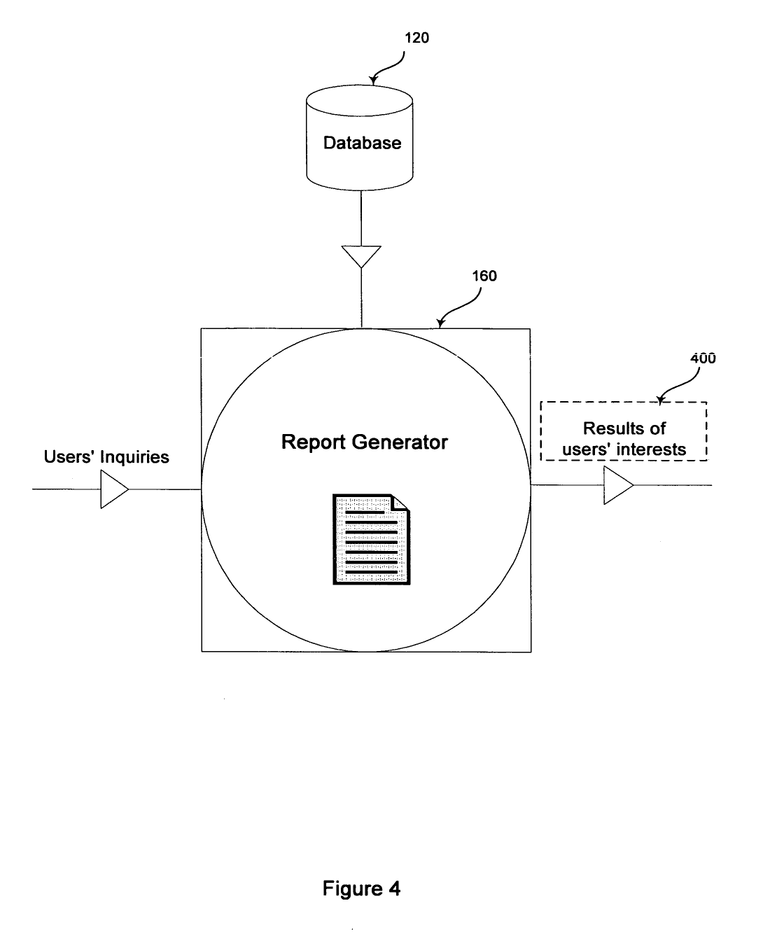

FIG. 4 illustrates operation of the statistical report generator 160 according to an embodiment of the invention. The statistical report generator 160 generates a statistical report 400 for marketing purposes based on a given parameter or a given series of parameters based on the available data in the database 120. For instance, the statistical report 410 could be a demographic study of the participants in the database 120 or a distribution of related parameters within an area of interest such as the distribution of various income levels of the participants over geographic regions, or the distribution of various ethnic groups of the participants for a given item category, etc. For example, if a camera manufacturer participant wishes to see the distribution of various income levels of customers who have purchased a particular item, such a distribution can be presented in the form of a chart.

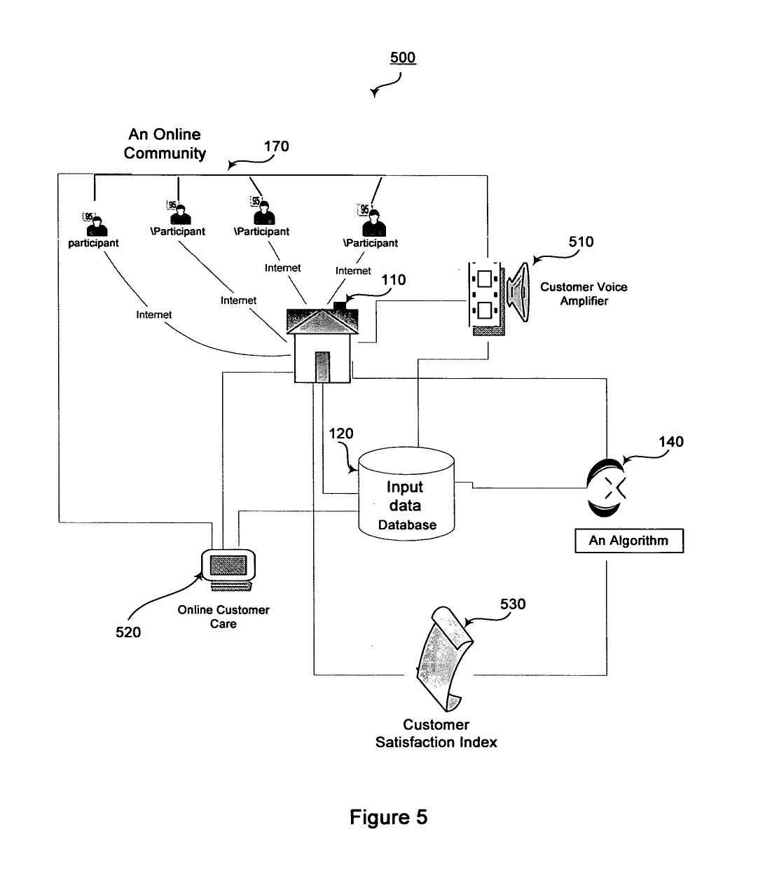

FIG. 5 illustrates a customer satisfaction and experience processing system 500 according to another embodiment of the invention. Particularly, the customer satisfaction and experience processing system 500 comprises a front interface 110, a database 120, a customer satisfaction processing algorithm 140, and one or more of the following: a customer voice amplifier 510, an online customer care facilitator 520, and a customer satisfaction index facilitator 530. Although not shown, the system 500 may further include one or more of the following: a search engine 130, an intelligent optimizer 150, and a report generator 160.

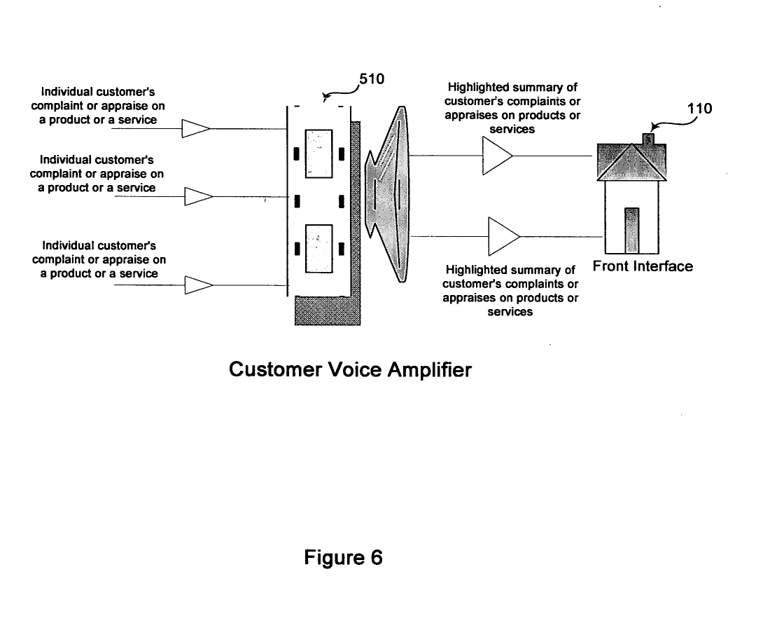

FIG. 6 illustrates operation of the customer voice amplifier 510 according to an embodiment of the invention. The voice amplifier 510 receives and processes information relating to complaints or negative feedback (or appraise) about particular items from one or more participants and generates a report to be forwarded to the provider or providers of such items, thereby leveraging the power of many customer voices. The report can include a highlighted summary of customers' complaints or praises for various items of the provider. In another embodiment of the invention, such a report could be made publicly available via front interface 110 for all participants to see until the underlying problem(s) are addressed by the provider. The customer voice amplifier 510 thereby leverages the power of many customers. Whereas, an individual customer might not be able to achieve resolution of a problem for a specific item on their own, many customers with similar problems can effectively leverage their power together to seek a meaningful resolution to the problem. An individual customer can start a group campaign once his/her individual efforts to get the provider's attention have failed.

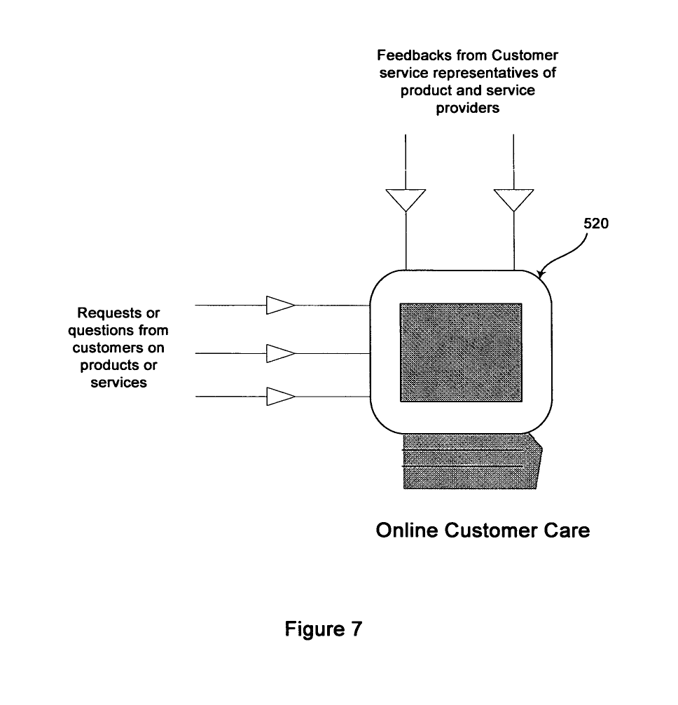

FIG. 7 illustrates operation of the online customer care facilitator 520 according to an embodiment of the invention. The online customer care facilitator 520 connects providers with their customers. For example, customers can send requests or questions to an item provider. In return, customer service representatives for the provider can provide feedback and/or technical assistance to the customer. Participants can share information about the online care provided by various providers. In a related embodiment of the invention, a representative of the provider can be recruited by the provider or the operator of the system 500 from the electronic community 170 (e.g., from a pool of participants in a particular topic or forum) based on the participant's credibility (such as his/her knowledge and participation level, etc.). In an embodiment of the invention, that representative will not be paid by the specific provider that he/she represents, but instead will be given certain privileges such as percentage discount/coupons all across the similar product lines, etc. The representative then advocates on behalf of the provider. Alternatively, representatives can be volunteers, who are not necessarily employees of any service/product provider. Communications between other customers and the representative can take place via a public or private channel.

In an embodiment of the invention, the online customer care facilitator 520 employs a unified customer care procedure/interface throughout multiple providers. For instance, a participant will be presented with a consistent customer care procedure/interface through facilitator 520 regardless of the respective provider. Thus, rather than learning two different customer care procedures/interfaces from, say, provider1.com and provider2.com who implement a different customer care procedures or web interfaces, a participant within the electronic community 170 only has to become familiar with one customer care procedure/interface via the facilitator 520. Once a participant is familiar with the single customer care procedure/interface of the facilitator 520, the participant can easily seek customer care assistance from other providers providing customer care via facilitator 520.

The customer satisfaction index facilitator 530 combines the customer satisfaction ranking score from a certain number of key industries and key providers in a industry to calculate a real time customer satisfaction index for an industry or for a country's overall economy. For instance, the customer satisfaction index can be based on a predetermined number of providers within a certain industry. A customer satisfaction index is computed based on the collective satisfaction ranking scores of all products or services provided by the predetermined number of providers. As participants input further customer satisfaction data into the system 500, the customer satisfaction index is updated in real time.

A participant within the electronic community 170 may decide upon the level of involvement he/she wishes based on the amount of his/her own identification information the participant is comfortable with disclosing. Participants may input their own satisfaction and experience with respect to any particular item in either numerical and/or written form, which they may post through messages or comments, and participants may search for other participants' ranking results, messages and comments on a particular item already stored in the system's database 120 on a real time basis. Participants may also interact with other participants on a peer-to-peer basis and may create new electronic groups/forums under a given criteria for any particular item not yet in the database 120.

In an embodiment of the invention, identification information for a particular participant is used to maintain the credibility and integrity of the database 120; however, such information is kept confidential. For example, without traceable personal information, fraud can take place when “fake” participants try to “distort” the fairness of the results for the item information maintained in the system. In an embodiment of the invention, those who don't reveal traceable personal information are allowed to participate, but their input will be discounted. The identification information may be used aggregated to present general statistical reports, but, the statistical reports will not contain personally-identifiable information. The identification information for individual participants can include, but is not limited to, name, address, email address, birth date, mother's maiden name, driver's license number, social security number, and credit card information. The identification information for a business entity participant can include, but is not limited to, name, address, and tax identification number.

In an embodiment of the invention, community participants comprise two levels of members, which are “untraceable” and “traceable.” For instance, when a participant initiates registration with the system, he/she can choose to open an account with a personal profile of traceable or untraceable information. A personal profile without traceable information is virtually just an email address. A personal profile with traceable information may include the participant's mailing address, driver's license number, a bank account, etc. A personal profile, either traceable or untraceable, can be kept confidential. The “untraceable” level doesn't necessarily have (or is not required to have) traceable information for the community participants while the “traceable” level has traceable information for community participants such as name, address, contact information and other forms of identification. Traceable information is used for the purpose of verification in customer surveys. The data input by a “traceable” participant has a greater weight than that inputted by an “untraceable” participant to maintain the credibility and integrity of the system.

Other embodiments and uses of the invention will be apparent to those skilled in the art from consideration of the specification and practice of the invention disclosed herein. Although the invention has been particularly shown and described with reference to several embodiments, it will be understood by those skilled in the art that various changes in form and details may be made therein without departing from the spirit and scope of the invention as defined in the appended claims.

1. A computer system for determining customer satisfaction with an item, the system comprising:
a database, wherein said database stores first data measuring one or more customer's satisfaction with a first item, wherein said first data includes two or more quantified values rating different aspects of customer satisfaction; and
a computing device for processing said first data and generating a customer satisfaction score for said first item.

2. The computer system of claim 1, wherein said computing device comprises a computer server enabling communication with one or more remote devices.

3. The computer system of claim 2, wherein a portion of said first data is received from said one or more remote devices.

4. The computer system of claim 1, wherein one of said different aspects of customer satisfaction is selected from a group consisting of: satisfaction with one or more functions and features of said item, satisfaction with basic services of said item, satisfaction with extended services of said item, satisfaction with personal services of said item, a price of said item, a value of said item, an overall satisfaction with said item, a recommendation of said item, a performance of said item, or a combination thereof.

5. The computer system of claim 1, wherein said customer satisfaction score comprises two parameters, each of said parameters representing a value of one of said quantified values rating different aspects of customer satisfaction statistically computed over a plurality of customers.

6. The computer system of claim 1, wherein said customer satisfaction score comprises an overall grade based on said two or more quantified values rating different aspects of customer satisfaction.

7. The computer system of claim 6, wherein said computing device processes second data measuring one or more customer's satisfaction with a second item, generates a customer satisfaction score for said second item, and ranks said first item relative to said second item according to said customer satisfaction scores.

8. The computer system of claim 2, further comprising a search engine, wherein said search engine permits said one or more remote devices to locate said first data within said database.

9. The computer system of claim 6, wherein said computing device processes a personal profile of a customer or a prospective customer, and generates a list recommending one or more of said first and second items based on said personal profile.

10. The computer system of claim 6, wherein said computing device receives a personal profile of a customer or a prospective customer, and further comprising a report generator, wherein said report generator generates a report based on said personal profile and/or said first and second data.

11. The computer system of claim 1, wherein said item comprises a product or service, and said system is not biased toward a particular provider of said product or service.

12. A method for determining customer satisfaction with an item, the method comprising the steps of:
gathering first data relating to a plurality of customers' levels of satisfaction with respect to a first item, wherein said first data comprises two or more quantified values for each of said customers rating two different aspects of satisfaction with respect to said first item; and
generating a customer satisfaction score based on said first data for said first item.

13. The method of claim 12, wherein said step of gathering first data comprises the step of receiving said two or more quantified values for each of said customers from one or more remote devices.

14. The method of claim 12, wherein said customer satisfaction score comprises statistical values of said two or more quantified values for each of said customers statistically computed over all of said plurality of customers.

15. The method of claim 14, wherein said customer satisfaction score comprises an overall grade based on said statistical values.

16. The method of claim 12, further comprising the steps of:
gathering second data relating to a plurality of customers' levels of satisfaction with respect to one or more second items, wherein said second data comprises two or more quantified values for each of said customers rating two different aspects of satisfaction with respect to each of said second items; and
generating a customer satisfaction score based on a portion of said second data for each one of said second items.

17. The method of claim 16, further comprising the step of ranking said first and said second items relative to one another according to said satisfaction scores.

18. The method of claim 16, further comprising the steps of:
receiving a personal profile for a customer or a prospective customer, and
recommending one or more of said first and second items based on said personal profile.

19. The method of claim 16, further comprising the steps of:
receiving a personal profile for a customer or a prospective customer, and generating a marketing report based on said personal profile and/or said first and second data.

20. A computer system for recommending one or more items based on a personal profile of a customer, the system comprising:
a computer server, wherein said computer receives first data relating to a personal profile of a customer and an inquiry relating to a set of items, and
a database, wherein said database stores second data relating to one or more quantified satisfaction values pertaining to each one of said set of items as surveyed from a plurality of customers,
wherein said computer server processes said personal profile, said first data, and said second data, and generates a list of one or more recommended items selected from said set of items based upon said personal profile of said customer.

21. The computer system of claim 20, wherein said customer profile comprises information selected from the group consisting of: a name, an age, an occupation, an income level, an address, an educational level, a customer behavior, a purchasing characteristic, a personality trait, a technical prowess level, a past experience with an item provider, a budget, a preferred feature sought in an item, an intended use for an item, or a combination thereof.

22. The computer system of claim 20, wherein said second data comprises one or more ranking scores pertaining to said set of items.

23. The computer system of claim 20, wherein said computer server forwards said list of one or more recommended items to a remote device of said customer.

24. The computer system of claim 20, wherein said quantified satisfaction values comprises two or more ratings for different aspects of customer satisfaction with respect to an item.

25. A method for recommending one or more items based on a personal profile of a customer, the method comprising the steps of:
receiving a personal profile of a customer and an inquiry relating to a set of items,
obtaining one or more quantified satisfaction values pertaining to each one of said set of items as surveyed from a plurality of customers,
generating a list of one or more recommended items selected from said set of items based upon said personal profile of said customer and said one or more quantified satisfaction values pertaining to each one of said set of items.

26. The method of claim 25, further comprising the step of forwarding said list of one or more recommended items to a remote device of said customer.

27. The method of claim 25, wherein said quantified satisfaction values comprises two or more ratings for different aspects of customer satisfaction with an item.

28. A method for researching customer satisfaction with respect to an item, the method comprising the steps of:
sending an inquiry about an item to a centralized facilitator, and
receiving, from said centralized facilitator, a satisfaction score for said item based upon a survey measuring one or more customer's satisfaction with said item, wherein said survey comprises two or more quantified values rating different aspects of customer satisfaction.

29. The method of claim 28, wherein the inquiry is sent by a device remote from said centralized facilitator and having Internet access.

30. The method of claim 28, wherein said customer satisfaction score comprises two parameters, each of said parameters representing a value of one of said quantified values rating different aspects of customer satisfaction statistically computed over a plurality of customers.

31. The method of claim 28, wherein said customer satisfaction score comprises an overall grade based on said two or more quantified values rating different aspects of customer satisfaction.

32. A method for obtaining a recommendation of one or more items from a set of items, the method comprising the steps of:
sending a personal profile and an inquiry relating to set of items, and
receiving a list of one or more recommended items selected from said set of items based upon said personal profile and one or more quantified satisfaction values pertaining to each one of said set of items as surveyed from a plurality of customers.

33. The method of claim 32, wherein said inquiry is sent by a device remote from said centralized facilitator and having Internet access.

34. The method of claim 32, wherein said quantified satisfaction values rate different aspects of customer satisfaction and are statistically computed over said plurality of customers.

35. The method of claim 32, wherein each of said quantified satisfaction values comprises an overall grade based on overall customer satisfaction.

36. A method of assimilating customer feedback, the method comprising the steps of:
collecting feedback from the plurality of customers as it relates to an item provided by a provider,
processing said feedback from a plurality of customers into first data, and
forwarding said first data to said provider.

37. The method of claim 36, wherein said feedback comprises negative feedback.

38. The method of claim 37, wherein said first data comprises a complaint.

39. A method for calculating a customer satisfaction index, the method comprising the steps of:
collecting data relating to a plurality of customer's satisfaction with a plurality of items provided by a plurality of providers,
calculating a customer satisfaction score for each of said plurality of items based on a portion of said collected data, and
calculating a customer satisfaction index across said plurality of providers based on said customer satisfaction score calculated for each of said plurality of items.

40. The method of claim 39, wherein said step of calculating a customer satisfaction index is updated as said data is collected.

41. A method of providing online customer care and support, the method comprising the steps of:
facilitating communication between a plurality of customers of an item provider with said provider, and
selecting one of said customers to serve as a representative of said provider, and
facilitating communication between said selected customer and others of said plurality of customers.

42. The method of claim 41, wherein said selected customer provides customer care and support from said provider to said others of said plurality of customers.

43. A method of providing online customer care and support, the method comprising the steps of:
facilitating customer care and support among a plurality of item providers, and
implementing a unified customer care procedure or interface across said plurality of item providers.
